(19) United States
(12) Patent Application Publication
(10) Pub. No.: US 2026/0156129 A1
(43) Pub. Date: Jun. 4, 2026

(54) DISTINGUISHING ABUSIVE TRAFFIC FROM LEGITIMATE TRAFFIC WITH MULTI-STAGE VOLUMETRIC ANALYSIS

(71) Applicant: Akamai Technologies, Inc., Cambridge, MA (US)

(72) Inventors: David Senecal, Fremont, CA (US); Spandan Brahmbatt, Plano, TX (US); Nils Rehm, Bremen (DE)

(21) Appl. No.: 18/967,534

(22) Filed: Dec. 3, 2024

(51) Int. Cl. H04L 9/40

(52) U.S. Cl. CPC H04L 63/1425; H04L 63/0245

(57) ABSTRACT

This disclosure describes techniques to distinguish between attack traffic and legitimate user traffic at a site and take action on those findings. A system monitors traffic volumes to the site to determine whether it falls within predicted levels based on historical patterns. If traffic volume deviates from predicted levels, then traffic is analyzed by client signatures (such as a tuple of operating system and user agent) to determine whether the deviation is due to a subset of client signatures rather than factors that are more broadly applicable across clients. A subset of client types driving increased traffic levels may indicate an attack. Based on this intelligence the system can take action to mitigate the traffic or, if legitimate traffic, adjust the general forecasting model.

### BACKGROUND

### Technical Field

This patent document relates to network security and network traffic analysis and management.

### Brief Description of the Related Art

Distributed computer systems are well-known in the prior art. One such distributed computer system is a “content delivery network” (CDN) or “overlay network” that is operated and managed by a service provider. The service provider typically provides the content delivery service on behalf of third parties (customers) who use the service provider's shared infrastructure. A distributed system of this type typically refers to a collection of autonomous computers linked by a network or networks, together with the software, systems, protocols and techniques designed to facilitate various services, such as content delivery, web application acceleration, or other support of outsourced origin site infrastructure. A CDN service provider typically provides service delivery through digital properties (such as a website), which are provisioned in a customer portal and then deployed to the network. A digital property typically is bound to one or more edge configurations that allow the service provider to account for traffic and bill its customer.

In connection with serving content from a CDN server, or other web infrastructure, it is known to provide a JavaScript-based technology to fingerprint clients and to collect telemetry to evaluate the user behavior and differentiate bots from humans. This technology can be useful to protect transactional workflows such as login, checkout, search, gift card validation, coupons/rebates processing, etc., and that are regularly the target of fraud activity using botnets.

Generally speaking, fingerprints serve to identify a user, user agent, or device via configuration settings or other observable characteristics. It is known in the art by others that some characteristics can be passively collected on the server, such as network protocol information that reflects how a client or user agent connects to a server (TCP connection settings, TLS ciphers and extensions, and HTTP headers), IP address and information that can be inferred from it such as geography/location or autonomous system number (ASN). Other characteristics are collected actively, for example with the aforementioned Javascript technology. In this technique, the site provides a script that the client downloads and executes. The script gathers information from the client device, such as hardware and software installed, user preferences, as well as performance information. Using a fingerprint, a particular client or class of clients can be tracked statistically, e.g. to understand its historic request rate or navigation pattern, and to develop reputation scores, all already known in the art by others.

Further information about bot-detection technologies can be found in U.S. Pat. Nos. 11,374,945 B1, 11,368,483 B1, 11,245,722 B1, and 11,184,390 B2, the contents of which are hereby incorporated by reference.

It is also known in the art to provide systems to protect sites from volumetric attacks by filtering traffic when traffic volumes exceed thresholds. Further information about volumetric attack protection can be found in US Patent and Patent Publication Nos. 7,478,429 B2, 10,673,891 B2, and US 2013/0254343 A1, the contents of which are hereby incorporated by reference.

Many times, abusive bot traffic (attacks, misuse, etc.) is volumetric because the bots are attempting to complete a task that requires making many requests as fast as possible. As a result, defenders pay close attention to shifts in traffic volume trends. Several methods are commonly used to help monitor traffic volumes. In its simplest form, one can determine the historical minimum (Min) and maximum (Max) levels and set up alerts when these thresholds are breached. Breach of the Max might indicate an attack. Breach of the Min might indicate a system outage or a change in traffic patterns. This method has the merit of being simple, but the thresholds have to be set to the extreme Min and Max values to avoid recurring false positive alerts, which allows a malicious actor plenty of headroom and in the end, makes this strategy ineffective.

More advanced methods rely on machine learning models to forecast traffic. A model is typically trained based on several days of traffic, e.g., 2 to 4 weeks. Training with more data is possible but costly. Because of the limited data set used to train the model, the narrow time window may not represent all variations of traffic seen on the website throughout the year. Even if a year's worth of data were used for training a forecasting model, event dates are unlikely to align year over year. Common known forecasting models are the Fast Fourier Transform, Auto Regression Integrated Moving Average, or more advanced models like Facebook's Prophet or Amazon's GluonTS.

Existing models work well. But they all have the common drawback: they are unable to predict uncommon/unpredictable events such as flash sales, limited edition product releases (such as concert ticket sales of a famous band, sneakers), or the start of new marketing campaigns. All of these events (and others) can lead to significant shifts in the traffic trends that the forecasting model cannot predict since they do not have any historical antecedent in the training data.

The teachings of this document enhance existing forecasting models with techniques to evaluate whether deviations in traffic compared to the forecast are legitimate or are abusive (attacks, misuse of the site, etc.). Such findings can be used not only to improve future forecasting but to take mitigation actions against the traffic. The teachings hereof can be used, over time, to reduce false positives and false negatives in alerts and improve overall detection accuracy and user experience. This model also does not require human intervention.

Accordingly, the teachings presented herein improve the security and functioning of a computer system itself, such as website servers. Those skilled in the art will understand these and other improvements from the teachings hereof.

### BRIEF SUMMARY

This section describes some pertinent aspects of this invention which are illustrative, not exhaustive. They are not a definition of the invention.

This disclosure describes techniques to distinguish between abusive traffic and legitimate user traffic at a site when traffic deviates from general forecasts. A system monitors traffic volumes to the site to determine whether it falls within predicted levels, based on historical patterns. If traffic volume deviates from predicted levels, then traffic is analyzed by client signatures (such as a combination of operating system and user agent) to determine whether the deviation is due to a subset of client signatures rather than other more broadly applicable factors. When a subset of client signatures is largely driving the increased traffic levels, it may indicate an attack or other abusive behavior. Based on this intelligence the system can take action to mitigate the traffic. If the subset of client signatures is not driving the increased traffic levels, the traffic observations can be deemed benign and incorporated into the general model for traffic forecasting at the site.

In preferred embodiments, a first machine learning model is used for a first-level analysis of overall traffic volumes. That first model is trained on historical traffic patterns to the site. The corpus of traffic may represent all traffic at the site, or all traffic in a particular geographic region, or other generalized segment of traffic. A second machine learning model is used for a second-level analysis of traffic by client signature. That second model is trained on historical traffic patterns of traffic for each of a plurality of client signatures that are defined by characteristics such as operating system and user agent and others, as will be explained below. Preferably there are a relatively small number of client signatures defined so as to negate the effect of malicious actors using (or spoofing the use of) slightly different clients.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a diagram illustrating a process for evaluating traffic at a site, in accordance with one embodiment of the teachings hereof;

FIG. 2 is a diagram illustrating actual and predicted traffic levels at a site;

FIG. 3 is a diagram illustrating actual and predicted traffic levels at a site, with a spike in actual traffic;

FIG. 4 is a diagram illustrating traffic at a site for each of a plurality of client signatures;

FIG. 5 is a diagram illustrating traffic at a site for each of a plurality of client signatures;

FIG. 6 is a diagram illustrating traffic at a site for each of a plurality of client signatures, with one of the client signatures being an outlier;

FIG. 7 is a diagram illustrating how the overall traffic forecast is adjusted with actual observations when the anomalous traffic is determined to be legitimate;

FIG. 8 is a diagram illustrating how the overall traffic forecast is not adjusted with actual observations when the anomalous traffic is determined to be suspicious; and,

FIG. 9 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refers to potential advantages and benefits that may be obtained through the practice of the teachings hereof. It is not necessary to obtain such advantages and benefits in order to practice the teachings hereof.

All references to HTTP should be interpreted to include an embodiment using encryption (HTTP/S), when TLS secured connections are established. While context may indicate the hardware or the software exclusively, should such distinction be appropriate, the teachings hereof can be implemented in any combination of hardware and software. Hardware may be actual or virtualized.

### Site Traffic

An important difference between abusive traffic and legitimate high-volume user traffic is that one would expect the volume of most client signatures to increase at the same pace during an event. In contrast, with attacks or other abusive traffic, typically only a subset (generally a small subset) of client signatures increase their volume. That subset is the source of the abuse. The teachings hereof aim to (among other things) identify this difference and automatically adjust a traffic forecast based on whether the volume increase is seen across client signatures. If traffic increases commensurately across signatures, this tends to indicate that the increased traffic is legitimate, possibly from a successful event like a flash sale. If the increase does not seem legitimate, then the forecast is not adjusted.

To better understand the nature of legitimate vs. illegitimate traffic, consider the example of a website running a sale or promotional event. Such events typically target a broad variety of end-users who use different types of devices (e.g., phones, tablets, laptops, desktops, game consoles) running various combinations of software versions (Windows+Edge, MacOS+chrome, Android+Firefox, iOS+Safari, etc . . . ). Even in the case of restricted promotion events (e.g., exclusive membership, or a geographic specific promotion), end-users will own a wide variety of devices, and it is expected that the traffic will be distributed between the different hardware and software categories (the signatures).

More specifically, take an hypothetical e-commerce website with a promotional event. The traffic from end users will not be exclusively coming from, e.g., Chrome v97 running on Windows 10. Instead one would expect to see a variety of client-side configurations with various versions of browsers (e.g., Chrome, Safari, Firefox, Opera) running on a variety of operating systems such as Windows, macOS, iOS, and Android, and so on. When traffic volume exceeds the traffic forecast during a sales event, one would expect the increase in volume to be commensurate across the different signatures. Put another way, the composition of the traffic in terms of clients will remain roughly the same. Abusive traffic, however, often has a different traffic profile. Some attackers may attempt to hide by randomizing the fingerprint information, but they can never truly reproduce the typical “blend” of traffic seen on a website during normal operation.

### Overview

In a preferred embodiment, the proposed method consists of two models. First, a known forecasting model evaluates the traffic quantitatively by predicting the overall traffic volume based on historical data. Then a secondary model that evaluates the traffic qualitatively by assessing the characteristics of clients causing the traffic. This evaluation is done by assessing the fingerprint of the devices sending traffic (e.g. in a conventional manner as described previously). A client signature is derived from the received fingerprint and then used as part of a machine-learning model to forecast the expected volume for the given signature based on historical data. Preferably, the client signatures are used to categorize clients; in effect, the signatures represent a group or class of clients. Put another way, the client signatures represent buckets defined by a set of characteristics of the client. Generalizing, a client signature may be based on a tuple of device hardware characteristics (e.g., screen size, graphic card, CPU, . . . ), user software characteristics (e.g., browser, operating system, plugins, . . . ), user preferences (e.g., country, languages, timezone), protocol characteristics (e.g., TCP, TLS, HTTP), and network data (e.g., Autonomous system number, connection type).

In operation, a real-time component monitors the current traffic volume for a given site (e.g., against a given domain or set of domains) against the forecast (first model) for the corresponding time period. When an anomaly in the traffic pattern of the model is detected with a significant deviation from the forecast, a secondary evaluation (second model) is invoked to assess whether the anomaly is legitimate or not.

With the foregoing by way of non-limiting overview to introduce certain concepts, further details are now provided.

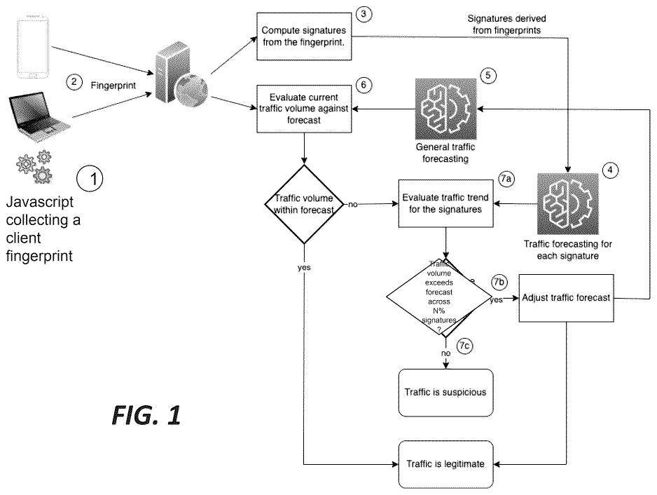

FIG. 1 illustrates a system embodiment in accordance with the teachings hereof. The system comprises client-side software (JavaScript or mobile SDK) running on the client devices (1) that communicate with the detection service. The client-side software is designed to collect various device and browser characteristics that describe the client device, which is often referred to as the fingerprint. The software causes the client device to send this information to the server (2) running the detection against fraud or bots. In addition, the server itself may collect data points about the client's usage of certain network protocols (HTTP, TLS, TCP) to supplement the fingerprint.

The detection service may be running in conjunction with a web server (2) serving content for the site the client is visiting. More generally, it should be understood that data collection could be done synchronous to the content delivery or asynchronous. In the former case, the server (2) can provide both the delivery and detection services. In the latter case, the server (2) receives beaconed data and processes it into actionable intelligence that is then communicated to delivery servers to use when the botnet returns.

Further information about gathering the fingerprint data can be found in U.S. Pat. Nos. 11,374,945 B1, 11,368,483 B1, 11,245,722 B1, and 11,184,390 B2, the contents of which are hereby incorporated by reference.

Returning to FIG. 1, at (3) the fraud/bot detection service can extract the fingerprint and derive a set of client signatures with various levels of granularity. The simplest signatures may include a few characteristics such as the name and version of the operating system (Windows, MacOS, iOS, Android, . . . ) , the name, and version of the browser (Chrome, Firefox, Safari, Edge, Opera, . . . ) , the type of platform (win64, Macintel, Linux, . . . ) , or the graphic card model. More advanced signatures may include all the characteristics of the simple signatures plus additional characteristics describing the software and hardware on the client device, such as the screen size, the list of supported fonts, the full user agent, and the number of core CPUs installed. These different signatures are used to train (at 4) a forecasting model to predict the traffic volume for each of the signatures based on historical data leveraging conventional machine models that are known in the art, such as Facebook Prophet or Amazon GluonTS. This is referred to as the “signature-aware model” below. The signature aware model can be re-calculated from time to time to account for the release of new client devices and/or software versions.

The breadth of the signatures is configured based on the site, the traffic mix to the site in normal times, and the particular implementation goals. In general, a good goal is to slice the data so that the models gain both a macro and micro view of the site traffic to detect anomalies. Examples of signatures of varying breadth could be, for example, a hash of TLS characteristics (at the broadest end) compared to a TLS hash+Browser name+Browser version+OS name+OS version+Country (a more narrow signature category). Hence the method envisioned here may need to involve a step of merging statistics that had been collected for multiple (more narrow) client fingerprints into a broader signature.

In parallel, another machine learning model is trained to forecast the overall traffic volume for the site (e.g., per domain or set of domains) based on historical data. This is shown at (5) in FIG. 1. This may be done in conventional ways, as known in the art.

In one implementation, both the signature-aware model and the overall traffic model are trained on the last 24 hours worth of site traffic. The models can be updated in near real-time, e.g., such that they reflect a rolling 24 hours period.

When the system is operating, the traffic volume for a given time period (e.g., date/day/time) is compared to the prediction for overall traffic (6) at that time period. If the current traffic volume does not exceed the forecast, the traffic is deemed legitimate by this system (“yes” path in FIG. 1). If the current traffic volume exceeds the forecast or exceeds by a configured tolerance threshold, then the system evaluates the traffic with the trained signature-aware model (“no” path, to 7a).

If a sufficient number or proportion of signatures from the signature-aware model show the same increasing trend where the forecast is exceeded, the traffic increase seen at the global level will be considered legitimate, and the forecast will be adjusted (7b). The term “sufficient number” of signatures is used here to indicate that the threshold is configurable and will depend on the traffic, typical site usage and client breakdown, and techniques used by malicious actors (which evolve over time). As a general starting point, if at least 60% of signatures from the signature-aware model show the same increasing trend where the forecast is exceeded, then path 7b can be invoked; the threshold value will be tuned over time.

On the other hand, if only a subset of signatures (e.g., 40% or less) from the signature-aware model shows the same increasing volume trend, then the traffic increase will be considered suspicious, and the global traffic forecast will not be adjusted, causing an alert or the detection engine to flag the traffic for the client signatures that shows the increase (7c). In turn, this determination can be fed to the content delivery servers that are receiving request(s) from the client (which, as mentioned, may be the server shown at 2 in a synchronous architecture or could be a separate web server fronting server 2 in an asynchronous approach).

It should be understood that the 60% vs. 40% ratio mentioned in the preceding two paragraphs should be considered a default threshold when initially introducing the system; as mentioned, these values may be adjusted over time to adapt to the typical behavior observed on the site.

Again, the size of the subset that leads to 7c is tunable; it is related to the 7b threshold.

### Model Description

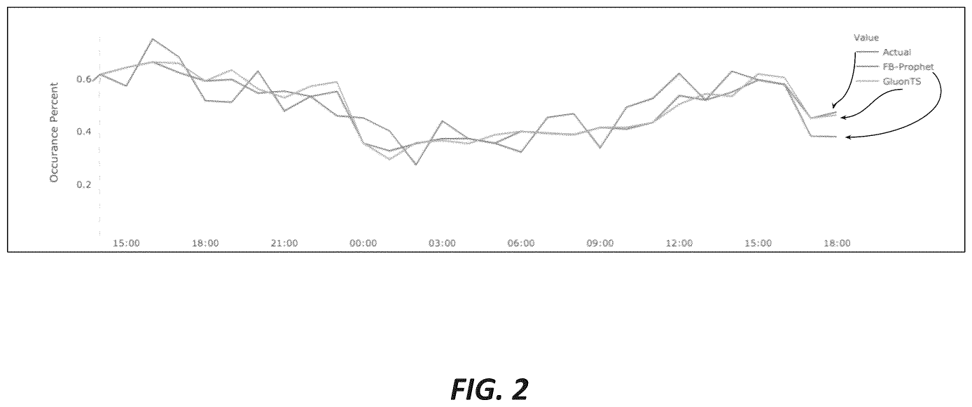

FIG. 2. Forecasting overall traffic volume. A machine learning model can forecast overall traffic volume based on historical trends, as seen in FIG. 2. The blue line corresponds to the actual traffic, and the red and green lines correspond to forecasted traffic using the Prophet and GluonTS algorithms, respectively. The forecast is done for all traffic (or some region or portion of the site), and then also for specific signatures (OS name and version+Browser name and version).

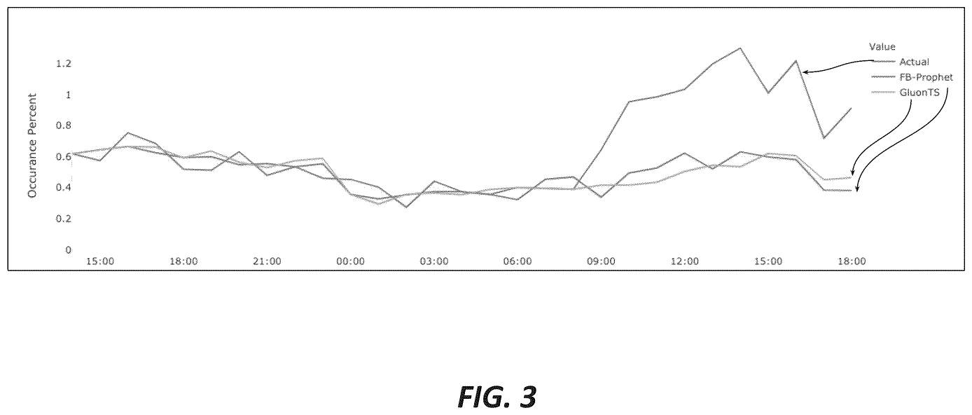

FIG. 3. Sales or other special events may significantly increase the traffic beyond what the system can forecast based on historical data, even if some margins are included. An example is shown in FIG. 3, where the actual traffic spikes. A deeper assessment of the traffic that causes the spike is required to evaluate whether the forecast must be adjusted.

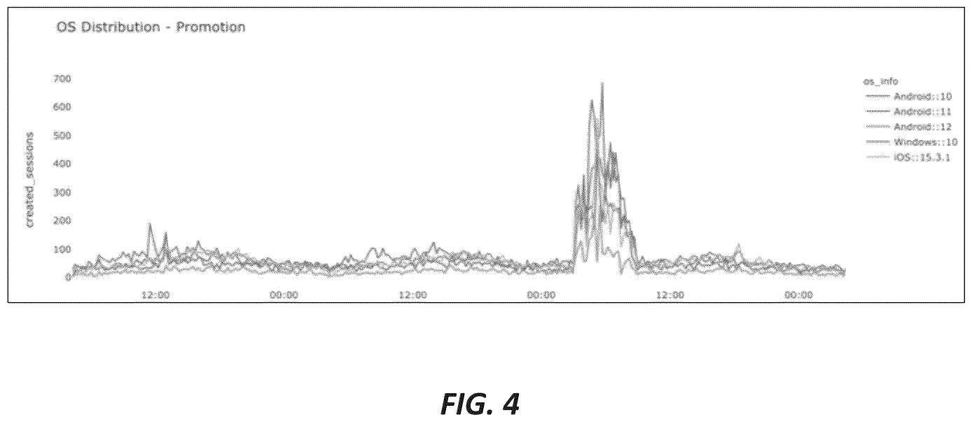

FIG. 4. A deeper assessment can be done by evaluating the type of traffic responsible for the spike. In FIG. 4, the client signature is the name of the operating system and version making the request. There is a commensurate increase in traffic across all OS+version combinations, which is what we expect from a sales event.

As mentioned, one may decide to leverage other attributes to assess the traffic, such as browser name and version or a combination of OS name, browser name, and platform leading to signatures that may look like this:
macOS::Chrome::MacIntel
Window::Edge::win64
iOS::Safari::iPhone
Android::Firefox::Arm

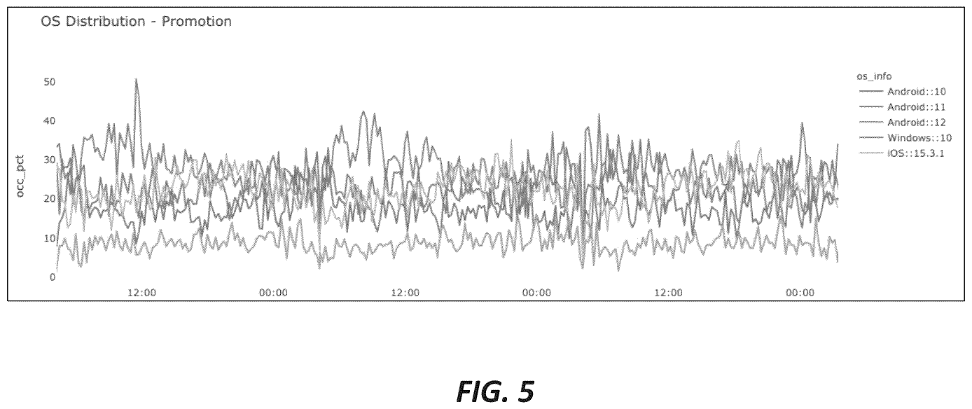

FIG. 5. Preferably, the number of attributes used to define a client signature should remain limited to avoid blurring the signals caused by fingerprint randomization methods typically used by malicious actors. Looking at it from the traffic percentage distribution point of view to eliminate the diurnal circadian pattern, in FIG. 5, we can see that it does not fluctuate in significant ways.

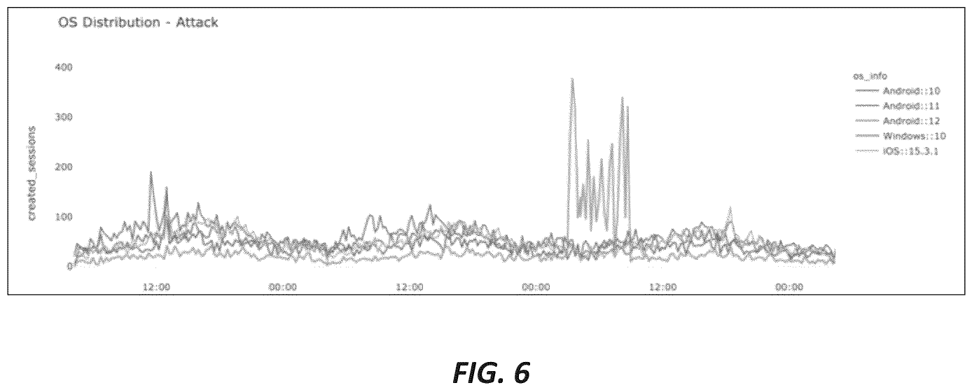

FIG. 6. However, in the case of an attack, we see only one of the OS+version combinations (Android::12) significantly rises, whereas the rest of the pattern stays the same.

This behavior is inconsistent with what we expect of legitimate traffic as the sales event will likely interest users that own various types of client devices that run different OS (Windows, iOS, etc.), not just one particular one. This traffic should be considered suspicious and potentially abusive.

Again, looking at the traffic percentage distribution point of view, we can see a disruption in the pattern for the Android::12 signature. In contrast, the traffic for the rest of the signatures remain more or less constant.

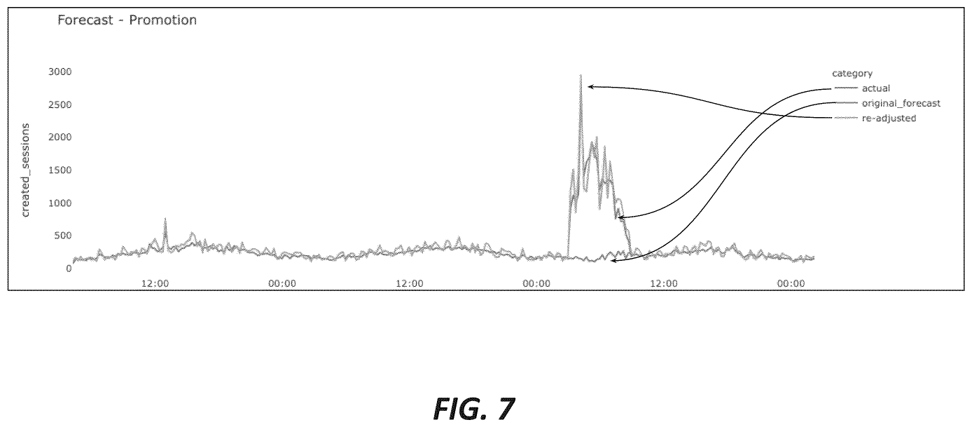

FIG. 7. When the traffic increase is commensurate across all platforms/OS, the overall traffic prediction can be adjusted to incorporate this new information. Such increased client activity shall not be challenged or blocked. In FIG. 7, the red line (“original_forecast”) represents the original forecast, and the green line (“re-adjusted”) represents the forecast adjusted to the actual traffic.

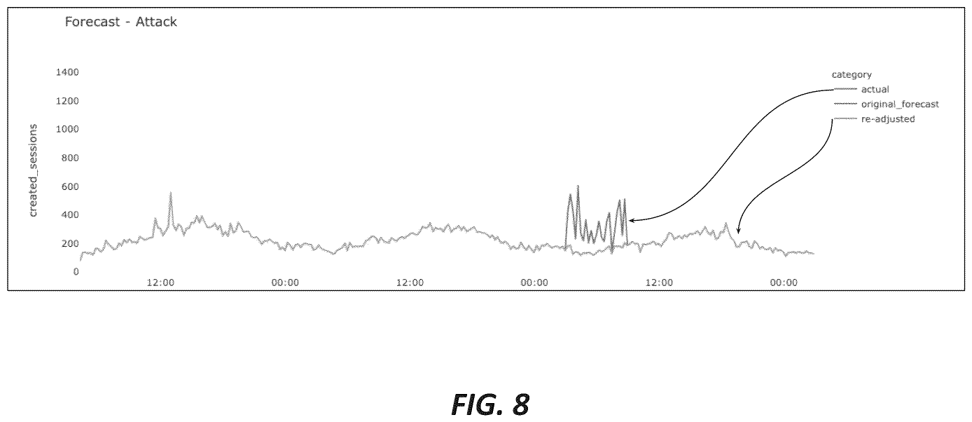

FIG. 8. If the traffic anomaly is identified as abusive, the forecast will not be adjusted, and the excess traffic compared to the forecast shall be alerted, challenged or blocked, or otherwise mitigated. FIG. 8 thus shows the adjusted traffic being the same as the original, not including the actual observed traffic. A “challenge” in this context means the presentation of a challenge to the client device such as a captcha, puzzle, or the like that is designed to differentiate between human users and bots.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus-such as a microprocessor in a computer, digital data processing device, or other computing apparatus-as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like.

References in the specification to a given embodiment indicate that the embodiment described may include a particular feature, structure, or characteristic, but every embodiment may not necessarily include the particular feature, structure, or characteristic.

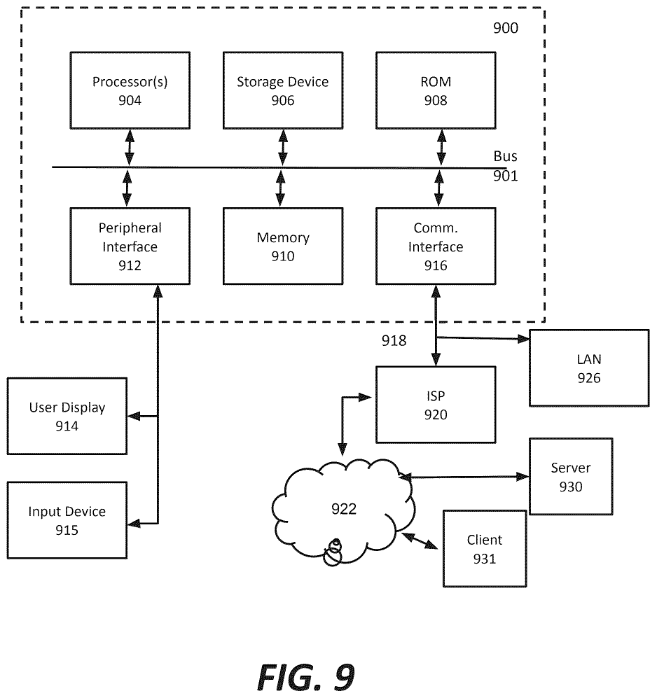

FIG. 9 is a block diagram that illustrates hardware in a computer system 900 upon which such software may run in order to implement embodiments of the invention. The computer system 900 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 900 includes a microprocessor 904 coupled to bus 901. In some systems, multiple processor and/or processor cores may be employed. Computer system 900 further includes a main memory 910, such as a random access memory (RAM) or other storage device, coupled to the bus 901 for storing information and instructions to be executed by processor 904. A read only memory (ROM) 908 is coupled to the bus 901 for storing information and instructions for processor 904. A non-volatile storage device 906, such as a magnetic disk, solid state memory (e.g., flash memory), or optical disk, is provided and coupled to bus 901 for storing information and instructions. Other application-specific integrated circuits (ASICs), field programmable gate arrays (FPGAs) or circuitry may be included in the computer system 900 to perform functions described herein.

A peripheral interface 912 may be provided to communicatively couple computer system 900 to a user display 914 that displays the output of software executing on the computer system, and an input device 915 (e.g., a keyboard, mouse, trackpad, touchscreen) that communicates user input and instructions to the computer system 900. However, in many embodiments, a computer system 900 may not have a user interface beyond a network port, e.g., in the case of a server in a rack. The peripheral interface 912 may include interface circuitry, control and/or level-shifting logic for local buses such as RS-485, Universal Serial Bus (USB), IEEE 1394, or other communication links.

Computer system 900 is coupled to a communication interface 916 that provides a link (e.g., at a physical layer, data link layer,) between the system bus 901 and an external communication link. The communication interface 916 provides a network link 918. The communication interface 916 may represent an Ethernet or other network interface card (NIC), a wireless interface, modem, an optical interface, or other kind of input/output interface.

Network link 918 provides data communication through one or more networks to other devices. Such devices include other computer systems that are part of a local area network (LAN) 926. Furthermore, the network link 918 provides a link, via an internet service provider (ISP) 920, to the Internet 922. In turn, the Internet 922 may provide a link to other computing systems such as a remote server 930 and/or a remote client 931. Network link 918 and such networks may transmit data using packet-switched, circuit-switched, or other data-transmission approaches.

In operation, the computer system 900 may implement the functionality described herein as a result of the processor executing code. Such code may be read from or stored on a non-transitory computer-readable medium, such as memory 910, ROM 908, or storage device 906. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 918 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method to manage traffic to a site, comprising:
applying current site traffic against a first machine learning model that has been trained against past traffic patterns at a site to predict traffic volume;
based on an indication that current traffic volume deviates from the predicted traffic volume for a current time period, applying current site traffic against a second machine learning model that has been trained against past traffic patterns at the site to predict a traffic volume from each of a plurality of client signatures; and,
based on an indication that the deviation from predicted traffic volume is being driven by a subset of the plurality of client signatures, taking an action to restrict traffic to the site.

2. The method of claim 1, wherein client signatures are characterized by one or more of: (i) hardware characteristics, (ii) software characteristics, (iii) user preferences, (iv) protocol characteristics, and (v) network characteristics.

3. The method of claim 1, wherein the client signatures are characterized by a closed set of characteristics selected only from the group consisting of: operating system, user agent information, hardware type.

4. The method of claim 1, where a size of the subset of the plurality of client signatures that triggers the action is configurable.

5. The method of claim 1, wherein the action comprises at least one of: applying a traffic filter, issuing an alert, and issuing a challenge to clients.

6. The method of claim 1, wherein the site is defined by one or more domains.

7. The method of claim 1, wherein the past traffic patterns used to train at least one of the first and second machine learning models comprise the last 24 hours of traffic.

8. The method of claim 1, further comprising: merging statistics for a plurality of narrow client fingerprints into a signature.

9. A system comprising circuitry forming at least one processor and memory holding computer program instructions for execution on the at least one processor to cause the system to:
apply current site traffic against a first machine learning model that has been trained against past traffic patterns at a site to predict traffic volume;
based on an indication that current traffic volume deviates from the predicted traffic volume for a current time period, apply current site traffic against a second machine learning model that has been trained against past traffic patterns at the site to predict a traffic volume from each of a plurality of client signatures; and,
based on an indication that the deviation from predicted traffic volume is being driven by a subset of the plurality of client signatures, take an action to restrict traffic to the site.

10. The system of claim 9, wherein client signatures are characterized by one or more of: (i) hardware characteristics, (ii) software characteristics, (iii) user preferences, (iv) protocol characteristics, and (v) network characteristics.

11. The system of claim 9, wherein the client signatures are characterized by a closed set of characteristics selected only from the group consisting of: operating system, user agent information, hardware type.

12. The system of claim 9, where a size of the subset of the plurality of client signatures that triggers the action is configurable.

13. The system of claim 9, wherein the action comprises at least one of: applying a traffic filter, issuing an alert, and issuing a challenge to clients.

14. The system of claim 9, wherein the site is defined by one or more domains.

15. The system of claim 9, wherein the past traffic patterns used to train at least one of the first and second machine learning models comprise the last 24 hours of traffic.

16. The system of claim 9, the computer program instructions further causing the system to merge statistics for a plurality of narrow client fingerprints into a signature.

17. A non-transitory computer readable medium holding computer program instructions that when executed cause at least one computer to:
apply current site traffic against a first machine learning model that has been trained against past traffic patterns at a site to predict traffic volume;
based on an indication that current traffic volume deviates from the predicted traffic volume for a current time period, apply current site traffic against a second machine learning model that has been trained against past traffic patterns at the site to predict a traffic volume from each of a plurality of client signatures; and,
based on an indication that the deviation from predicted traffic volume is being driven by a subset of the plurality of client signatures, take an action to restrict traffic to the site.
